(19) United States
(12) Patent Application Publication
(10) Pub. No.: US 2005/0216935 A1
(43) Pub. Date: Sep. 29, 2005

(54) Filter criteria and results display apparatus and method

(75) Inventors: Yuko Nishikawa, La Jolla, CA (US); Dayan Golden, San Diego, CA (US); Michael A. Bergeron, Poway, CA (US); Himgan Wibisono, San Francisco, CA (US); Philip McKay, San Francisco, CA (US)

Correspondence Address: FITCH EVEN TABIN & FLANNERY, 120 SOUTH LASALLE SUITE 1600, CHICAGO, IL, 60603, US

(73) Assignees: Sony Corporation, a Japanese corporation, Tokyo (JP); Sony Electronics Inc., a Delaware corporation, Park Ridge, NJ (US)

(21) Appl. No.: 10/806,832

(22) Filed: Mar. 23, 2004

(51) Int. Cl. H04N 7/173; H04N 7/16; G06F 13/00; H04N 5/445; G06F 3/00

(52) U.S. Cl. 725/37; 725/46

(57) ABSTRACT

Filter criteria for a plurality of characterizing descriptor filters are displayed along with characterizing descriptions of programming options that correspond to a present setting of the filters. A viewer readily navigates these displayed elements to discern available programming options and/or to view and select other filter criteria in an intuitive manner and without resort to nested menus.

### PROVISIONAL APPLICATIONS

We claim the benefit of Provisional Patent Application No. 60/520,752, entitled “Ring Interface for TV Programming Guide” and as filed on Nov. 17, 2003.

### RELATED APPLICATIONS

This application relates to each of the following applications, each of which is commonly owned and was filed on an even date herewith and each of which is hereby incorporated by this reference:

3 DIMENSIONAL BROWSING AND SELECTION APPARATUS AND METHOD (attorney's docket number 81231);

INTERACTIVE PROGRAM GUIDE WITH PREFERRED ITEMS LIST APPARATUS AND METHOD (attorney's docket number 81233);

DISPLAY FILTER CRITERIA AND RESULTS DISPLAY APPARATUS AND METHOD (attorney's docket number 81234);

AUTOMATIC CONTENT DISPLAY APPARATUS AND METHOD (attorney's docket number 81232);

CANDIDATE DATA SELECTION AND DISPLAY APPARATUS AND METHOD (attorney's docket number 81229);

MULTI-SOURCE PROGRAMMING GUIDE APPARATUS AND METHOD (attorney's docket number 81235).

### TECHNICAL FIELD

This invention relates generally to information displays and more particularly to the use of display filters and the navigation of displayed filter results.

### BACKGROUND

Information displays of various kinds are essentially ubiquitous in modem society. Many such displays serve, at least in part, to present content options to a viewer. As the number, kind, and constitution of such content options expand, a concurrent challenge arises to facilitate a way to navigate such options in a manner that is helpful and meaningful to the viewer.

Interactive programming guides are an example of such challenges. With cable, fiber, and/or satellite broadband services facilitating the delivery of an increasing number of varied programming options at any given time, it becomes more important to present a viewer with useful and helpful interface mechanisms to permit the viewer to be informed regarding available content options as the sheer magnitude of programming options renders unlikely the possibility that the viewer will be otherwise sufficiently knowledgeable in this regard.

Present suggestions regarding interactive programming guides as used with various audio/visual content services often present a number of candidate programming options on a display. In some cases this display will include a short textual description of the content of one or more of the candidate programming options or other static information (such as a rating, a brief listing of key actors, a year of publication, and the like).

Display criteria filters are sometimes used to limit in some predetermined or selectable fashion the particular candidate programming options that are displayed. For example, a viewer may be offered the option to limit the displayable pool of programming options to only those options that are presently available for viewing. While helpful in some instances to facilitate the content selection process, such an approach does not meet the needs of all viewers under all viewing circumstances. For example, filter control often requires navigation of nested setting choices (which are often presented in a series of nested menus). Navigation of such a configuration to locate a desired setting opportunity can be both cumbersome and non-intuitive. Further, the navigation process itself, coupled with the loss of present on-screen data, can permit some viewers to lose their train of thought and hence stymie rather than facilitate the subjective process of selecting viewing material of interest to the viewer.

### BRIEF DESCRIPTION OF THE DRAWINGS

The above needs are at least partially met through provision of the filter criteria and results display apparatus and method described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a display as configured in accordance with various embodiments of the invention;

FIG. 4 comprises a display as configured in accordance with various embodiments of the invention;

FIG. 5 comprises a portion of a display as configured in accordance with various embodiments of the invention; and

FIG. 6 comprises a display as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, characterizing descriptors as individually correspond to a plurality of discrete selectable items of data are provided. Two or more characterizing descriptor filters are also provided to permit and facilitate filtering of the plurality of these characterizing descriptors. One then simultaneously displays a first plurality of user-selectable characterizing descriptor filter criteria as corresponds to a first characterizing descriptor filter, a second plurality of user-selectable characterizing descriptor filter criteria as corresponds to a second characterizing descriptor filter, and at least a portion of the characterizing descriptors as corresponds to a present setting of the first and second plurality of user-selectable characterizing descriptor filter criteria.

In a preferred embodiment the characterizing descriptors comprise any of a variety of descriptors as may be relevant to a variety of audio/visual programs. Also in a preferred approach the user-selectable characterizing descriptor filter criteria as corresponds to the first characterizing descriptor filter are displayed in a segregated fashion with respect to the user-selectable characterizing descriptor filter criteria as corresponds to the second characterizing descriptor filter as well as the displayed characterizing descriptors. Similarly, the user-selectable characterizing descriptor filter criteria for the second filter are displayed in a segregated fashion with respect to the user-selectable characterizing descriptor filter criteria as correspond to the first characterizing descriptor filter as well as the displayed characterizing descriptors.

So configured, a viewer can readily navigate both within the available displayed (or displayable) viewing options as well as to and within the user-selectable characterizing descriptor filter criteria for both characterizing descriptor filters. In particular, such navigation can occur with such criteria and the resultant filtered options being readily viewable on a shared display. Movement within and between such displayed results and filter criteria therefore requires only an intuitive application of the on-screen highlighting/focus/cursor controls via, for example, a remote control as versus potentially more complicated and confusing nested menu navigation control interfacing.

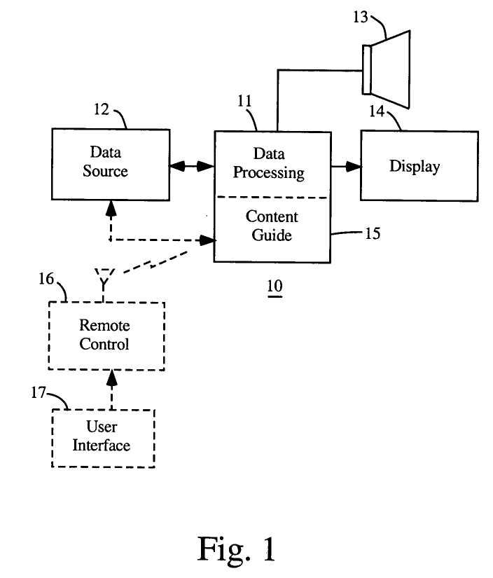

Referring now to the drawings, and in particular to FIG. 1, an apparatus 10 suitable to support and facilitate these teachings can comprise a data processing unit 11 that processes information from a data source 12 (or sources) and provides corresponding audio information to an audio processing path 13 and video information to a display 14.

The control circuitry of the data processing unit 11 can be embodied in a variety of ways. For example, the data processing unit 11 can comprise a fixed-purpose dedicated platform or can comprise a partially or fully programmable platform. Such options and architectural alternatives are well understood in the art and need no further elaboration here. In some embodiments, as with a so-called cable or satellite set-top box, the data processing unit 11 can be readily realized through appropriate programming of the processor as typically accompanies such an apparatus.

The data source 12 can comprise any presently known or hereafter developed data source. In a preferred embodiment the data source 12 provides audio/visual content such as television programs and movies. The data source 12 can provide access to wireless broadcast reception services, cable or optical fiber services, and/or satellite services, to name a few (either alone or in conjunction with one another). Depending upon the needs of the application, it is also possible that the data source 12 provides access to discrete selectable items of audio/visual content as are embodied in a plurality of media. For example, the data source 12 may provide access to cable programming options, satellite programming options, and local programming options as may be available via one or more local or otherwise available media drives (such as but not limited to video tape drives or digital video disk (DVD) drives). It is also possible that the data processing unit 11 operably couples to a plurality of such data sources to permit access to corresponding programming services and viewing options.

In a preferred embodiment this apparatus 10 further comprises a content guide 15. This content guide 15 can comprise an integral part of the data processing unit 11 (as suggested by the illustration in FIG. 1) or can comprise a physically separate platform that operably couples to the data processing unit 11. The content guide 15 can receive information regarding programming options in any of a variety of ways. For example, the data source 12 itself can source such information (either via the data processing unit 11 or directly via a dedicated coupling between itself and the content guide 15 engine). As another example, the content guide 15 can obtain such programming information in other ways such as via a dial-up link (not shown) that facilitates access to a server that provides such information.

In a preferred embodiment the content guide 15 further comprises two or more characterizing descriptor filters. The particular filters used can be selected as appropriate to the given needs and specific requirements of a given application. Some filter examples include, but are not limited to, a genre filter (with filter criteria such as “all,” “children's programming,” “comedy,” “drama,” “documentary,” “favorites list,” “service provider's recommendations,” “audio only,” and the like), a temporal filter (with filter criteria such as “now,” “upcoming within the next hour,” “tomorrow,” “previously recorded,” and the like), or a media/source filter (with filter criteria such as “broadcast television,” “satellite service 2,” “cable service 1,” “Internet content,” “DVD bank 1,” “digital video recorder 3,” and the like). Through use of such filters, an initial pool of candidate viewing choices can be reduced on the basis of the filter selection criteria as is generally well understood in the art. For example, by selecting a filter criterion of “now” for a first filter and a filter criterion of “children's” for a second filter, only presently viewable children's programming would be made available for selection browsing and navigation.

Such content guides are generally well understood in the art. The particular configuration and/or general operation of such engines is not especially important to these embodiments. Therefore additional detailed description will not be provided here regarding content guides except where appropriate below with respect to the description of these embodiments.

It will be understood that such apparatus 10 are often at least partially responsive to an optional wireless remote control 16. The latter often use infrared technology to facilitate communications but any wireless technology as may be appropriate to the needs of a given application can be utilized. In many instances such a remote control 16 will include a user interface 17 such as, for example, a keypad. Such a keypad will provide one or more keys that, when asserted by a user, will cause transmission of a particular corresponding wireless instruction by the remote control 16. Pursuant to a preferred embodiment, the operations of the content guide 15 will be at least partially configurable and/or otherwise controllable by appropriate remote control signals. Again, such remote controls are well understood in the art and require no further elaboration here.

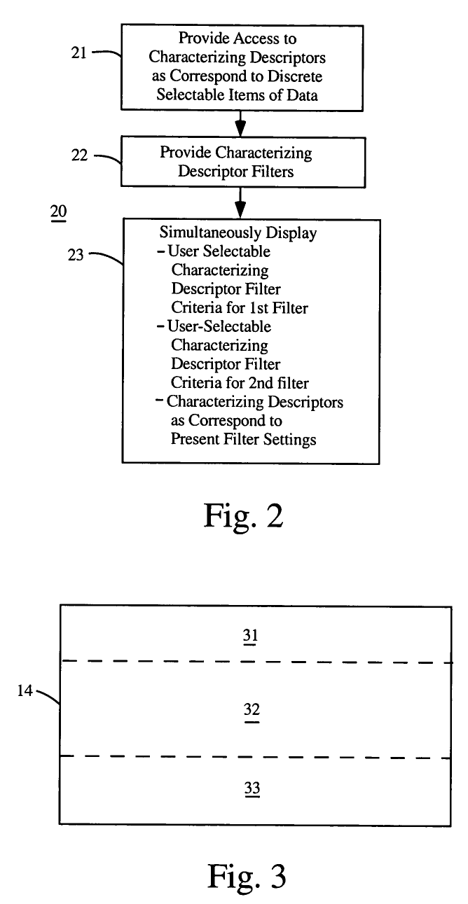

Referring now to FIG. 2, a process 20 that is readily supported by such an apparatus 10 (or that can be alternatively effected through any other suitable architectural configuration of choice) will be described. This process 20 provides for access 21 to characterizing descriptors as individually correspond to a plurality of discrete selectable items of data. In a preferred embodiment these discrete selectable items of data comprise items having audio/visual content (such as individual movies or television programs). The characterizing descriptors for such items of audio/visual content can be many and varied and can include, for example, a programming network identifier (such as the network call sign for a station that will broadcast or otherwise source the particular program), a broadcast starting time (or stopping time) for the program, a description (such as a textual description) of (or that otherwise pertains to) the audio/visual work, and an indication of the content media source itself (such as whether the program is available by cable, satellite, local media, or the like). The characterizing descriptors can also include samples of the video (and/or audio content) of the item itself and/or a previously prepared trailer or other preview or promotional sample for the item.

At least two user-selectable characterizing descriptor filters are then provided 22. As noted above, such filters have filter criteria that pertain to one or more of the characterizing descriptors for the selectable items of data. To illustrate, such criteria can pertain to content genre, content availability, content rating, content source, cost of content access, language, presentation duration, and the like. While it might be useful in some applications to have shared common criteria as between these two or more filters, in a preferred approach these filters will have mutually exclusive filter criteria sets. (The embodiments described below will presume for the ease of explanation and illustration that only two such user-selectable characterizing descriptor filters are so provided. It will be understood, however, that the invention is not so limited and that any number of additional filters can be added and used in a highly scalable fashion consistent with these teachings.)

This process 20 then provides for the simultaneous display 23 of a first plurality of user-selectable characterizing descriptor filter criteria as corresponds to the first characterizing descriptor filter, a second plurality of user-selectable characterizing descriptor filter criteria as corresponds to the second characterizing descriptor filter, and at least a portion of the characterizing descriptors as corresponds to a present setting of the first and second plurality of user-selectable characterizing descriptor filter criteria. In a preferred embodiment, this action further comprises not displaying any of the characterizing descriptors as do not correspond to the present setting of the first and second plurality of user-selectable characterizing descriptor filter criteria.

To facilitate such steps, and referring now to FIG. 3, a display 14 can be segregated, for example, into three separated display areas. A first display area 31 can be reserved for the display of the user-selectable characterizing descriptor filter criteria as corresponds to the first characterizing descriptor filter. A second display area 32 can be reserved for the display of the resultant characterizing descriptors as correspond to the present filter settings for both filters. And the third display area 33 can be reserved for the display of the user-selectable characterizing descriptor filter criteria as corresponds to the second characterizing descriptor filter. If desired, the entire display area (or some smaller subset) can also be used to simultaneously display a program of audio/visual content, such as a presently selected programming option, as a background or other adjunct to the filter criteria and characterizing descriptors.

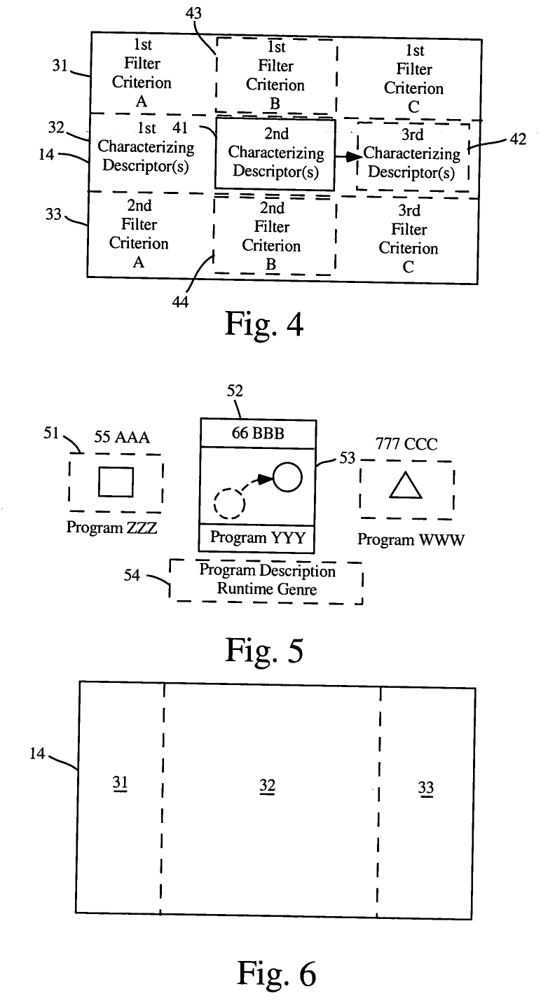

Referring now to FIG. 4, a plurality of filter criteria for the first characterizing descriptor filter can be simultaneously displayed in the first display area 31. Similarly, a plurality of filter criteria for the second characterizing descriptor filter can be simultaneously displayed in the third display area 33 while a plurality of resultant filtered characterizing descriptors are simultaneously displayed in the second display area 32. An area of focus 41 serves, in a preferred embodiment, to highlight a presently selectable displayed selection. Such focus capabilities are many and varied and are otherwise well understood in the art and include but are not limited to an overlying cursor icon, highlighting of the area of focus, use of reverse contrast, or application of a peripheral boundary indicator to visually indicate the area of focus, to name a few.

In the illustration of FIG. 4, the second characterizing descriptor (or descriptors) as appears in the second display area 32 resides within such an area of focus 41. In accord with ordinary practice, for example, the viewer can now select this programming option by asserting a corresponding “select” key on, for example, a remote control device. (Selection of a given programming option can result in an immediate display of that particular programming option, a scheduled recording of that programming option, or such other option as may be provided by a given system designer.)

In the alternative, a viewer can also move the area of focus to a new position (for example, by using a key that permits a scrolling action of the focus area in accord with prior art practice). For example, by causing the area of focus to move to the right, a new area of focus 42 will highlight the third characterizing descriptor(s) as is displayed in the second display area 32. Support of this functionality permits a viewer to select a given programming option according to their informed preference. In the illustrated embodiment, only three characterizing descriptor(s) are provided on the display 14. In the event that there are more than three available candidate characterizing descriptors available, additional descriptors can be accessed one-by-one by continuing to scroll the area of focus in a similar fashion to the right (or to the left to gain access to descriptors that are to the left of the first characterizing descriptor(s)). It would also be possible, in the alternative, to refresh the display and move on a page-by-page basis through the set of available characterizing descriptor(s).

(In these embodiments the area of focus is described as “moving.” In some embodiments it may in fact be desirable to provide to a viewer the image of an area of focus that moves with respect to the display to thereby coincide with different characterizing descriptors and the like. It is also possible, however, to effect relative movement as between an area of focus and such descriptors. For example, the area of focus can be maintained relatively stationary with respect to the display and the descriptors themselves are then caused to move with the respect to the area of focus to provide the desired navigation functionality. Those skilled in the art will appreciate and understand that all such navigation paradigms and approaches are compatible with and are otherwise subsumed within these teachings.)

As already noted above, these characterizing descriptors can comprise a wide variety of media type and information. In general, it is usually not practical to display all available characterizing information for each candidate programming option (if nothing else, such a display can overwhelm the viewer with a sheer bulk of unprioritized data). Instead, pursuant to a preferred approach and referring now momentarily to FIG. 5, a minimal subset of characterizing descriptors can be displayed for each of the programming options (such as the programming option denoted by reference numeral 51) while a more complete (or at least expanded) set of characterizing descriptors can be displayed for the programming option that is the present subject of the area of focus 52. For example, this expanded display can comprise a display of supplemental information 53 within the area of the original reduced display for the programming option and/or a display of supplemental information 54 that lies outside the area of the original reduced display area. And again, such supplemental information can comprise any useful information including particularly textual information (such as a program description, total runtime, content genre, and so forth) and/or other content such as an animated or video presentation.

So configured, each programming option will be presented in a reduced configuration that provides some limited amount of information content (such as broadcast channel and/or source call sign, program name, source or content logo, or a still graphic image that corresponds in some representative way to the programming option). Upon moving an area of focus to a given one of these programming options, however, a more complete presentation of characterizing information can be automatically provided. This presentation can include, or exclude, any of the information as is usually presented in the limited mode of presentation, but will preferably at least present information that is supplemental to such ordinarily presented information. This, in turn, permits a viewer to glean useful and helpful data to aid in developing a better informed selection of a given program option without necessarily overwhelming or stressing the cognitive processing capabilities of that viewer.

Referring again to FIG. 4, it is also contemplated that a viewer can move or scroll the area of focus in a vertical direction in this embodiment. This permits a viewer to move the area of focus upwardly to highlight, for example, filter criterion B 43 for the first characterizing descriptor filter. The viewer can then move the area of focus to the left or right to highlight and then select, as desired, other filter criterion as are available for this first filter in the first display area 31. In a similar fashion, the viewer can move the area of focus downwardly to highlight, for example, filter criterion B 44 for the second characterizing descriptor filter. And again, the viewer can then move the area of focus to the left or right to thereby highlight or select a desired different criterion for this second filter. Should additional filter criteria be available, such criteria can again be accessed by moving the area of focus off-display to cause such additional criteria to be displayed.

It is possible, of course, that additional filters may be available for use by the viewer. Depending upon the perceived needs of the application, it may be desirable to display such additional filters and their corresponding filter criteria on the display 14 by adding, for example, additional corresponding areas of display. In the alternative, or in addition to the above approach, it may also be possible to make such additional filters/criteria available by permitting the viewer to scroll off-display in the upward and/or downward direction to effect the display of such filters/criteria.

It can therefore be seen that a viewer can navigate a large number of programming options in a highly intuitive fashion (making use of only a few basic and intuitive commands). This navigation includes easy reference and access to filter criteria that in turn controls the subset of programming options that are presented for consideration and navigation. These benefits are realized without the need to access nested menus. These benefits remain essentially intact even though one scales the information set upwardly to include a relatively large body of data for any or all of the programming options and/or the filters and their filter criteria.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, and referring now to FIG. 6, the areas of display 31, 32, and 33 that segregate the display 14 into separate areas for displaying the filter criteria and the characterizing descriptors for the programming options can be vertically oriented with respect to one another rather than horizontally configured.

1. A method comprising:
providing access to characterizing descriptors as individually correspond to a plurality of discrete selectable items of data;
providing at least a first and a second characterizing descriptor filter;
simultaneously displaying:
a first plurality of user-selectable characterizing descriptor filter criteria as corresponds to the first characterizing descriptor filter;
a second plurality of user-selectable characterizing descriptor filter criteria as corresponds to the second characterizing descriptor filter;
at least a portion of the characterizing descriptors as corresponds to a present setting of the first and second plurality of user-selectable characterizing descriptor filter criteria.

2. The method of claim 1 wherein displaying at least a portion of the characterizing descriptors as corresponds to a present setting of the first and second plurality of user-selectable characterizing descriptor filter criteria further comprises not displaying any of the characterizing descriptors as do not correspond to the present setting of the first and second plurality of user-selectable characterizing descriptor filter criteria.

3. The method of claim 1 wherein providing access to characterizing descriptors as individually correspond to a plurality of discrete selectable items of data further comprises providing access to textual characterizing descriptors as individually correspond to a plurality of discrete selectable items of data.

4. The method of claim 1 wherein providing access to characterizing descriptors as individually correspond to a plurality of discrete selectable items of data further comprises providing access to characterizing descriptors as individually correspond to a plurality of discrete selectable items of audio/visual content.

5. The method of claim 4 further comprising:
simultaneously displaying at least one graphic image as individually corresponds to the at least a portion of the characterizing descriptors as corresponds to a present setting of the first and second plurality of user-selectable characterizing descriptor filter criteria.

6. The method of claim 4 wherein providing access to characterizing descriptors as individually correspond to a plurality of discrete selectable items of data further comprises providing access to characterizing descriptors that comprise at least one of:
a programming network identifier;
a broadcast starting time;
a description of the audio/visual content;
content media source.

7. The method of claim 4 wherein the plurality of discrete selectable items of audio/visual content are embodied in a plurality of media.

8. The method of claim 1 wherein the present setting of the first and second plurality of user-selectable characterizing descriptor filter criteria is selected in response to a remote control device.

9. The method of claim 1 wherein the present setting of the first and second plurality of user-selectable characterizing descriptor filter criteria is selected in response to a remote control device by scrolling through candidate settings of the first and second plurality of user-selectable characterizing descriptor filter criteria.

10. An interactive data display system comprising:
characterizing descriptors as individually correspond to a plurality of discrete selectable items of data;
at least a first and a second characterizing descriptor filter;
control circuitry that simultaneously displays:
at least one of a first plurality of user-selectable characterizing descriptor filter criteria as corresponds to the first characterizing descriptor filter;
at least one of a second plurality of user-selectable characterizing descriptor filter criteria as corresponds to the second characterizing descriptor filter;
at least a portion of the characterizing descriptors as corresponds to a present setting of the first and second plurality of user-selectable characterizing descriptor filter criteria.

11. The interactive data display system of claim 10 further comprising:
a remote control device for selecting the present setting of the first and second plurality of user-selectable characterizing descriptor filter criteria.

12. An interactive program guide system comprising:
characterizing descriptors as individually correspond to a plurality of discrete selectable items of audio/visual content;
at least a first and a second characterizing descriptor filter;
control circuitry that simultaneously displays:
at least one of a first plurality of user-selectable characterizing descriptor filter criteria as corresponds to the first characterizing descriptor filter;
at least one of a second plurality of user-selectable characterizing descriptor filter criteria as corresponds to the second characterizing descriptor filter;
at least a portion of the characterizing descriptors as corresponds to a present setting of the first and second plurality of user-selectable characterizing descriptor filter criteria.

13. The interactive program guide system of claim 12 further comprising:
a remote control device for selecting the present setting of the first and second plurality of user-selectable characterizing descriptor filter criteria.

14. The interactive program guide system of claim 13 wherein the remote control device comprises at least one key for scrolling through candidate settings of the first and second plurality of user-selectable characterizing descriptor filter criteria.

15. The interactive program guide system of claim 14 wherein the remote control device further comprises at least one key for moving a focus from one characterizing descriptor filter to another characterizing descriptor filter.

16. The interactive program guide system of claim 12 wherein the control circuitry further simultaneously displays a program of audio/visual content.

17. The interactive program guide system of claim 12 wherein the control circuitry further simultaneously displays a preview of a discrete selectable item of audio/visual content as corresponds to the present setting of the first and second plurality of user-definable characterizing descriptor filter criteria.
